(19) United States
(12) Patent Application Publication
(10) Pub. No.: US 2026/0368909 A1
(43) Pub. Date: Nov. 19, 2026

(54) Method for Training a Generative Machine Learning Model for Generating a Sequence of Poses of a Movable Object

(71) Applicant: Robert Bosch GmbH, Stuttgart (DE)

(72) Inventors: Dennis Mack, Sibbesse (DE); Maarten Bieshaar, Fritzlar (DE); Pascal Herrmann, Burgdorf (DE); Paul Robert Herzog, Hildesheim (DE)

(21) Appl. No.: 19/678,604

(22) Filed: May 15, 2026

(30) Foreign Application Priority Data
May 16, 2025 (DE) 10 2025 119 088.7

(51) Int. Cl. G06T 7/20; G06T 7/70; G06T 13/40; G06T 17/20

(52) U.S. Cl. CPC G06T 7/20; G06T 7/70; G06T 13/40; G06T 17/20; G06T 2207/10016; G06T 2207/20081; G06T 2207/20084; G06T 2207/30196

(57) ABSTRACT

A method for training a generative machine learning model for generating a sequence of poses of a movable object according to a movement of the movable object is disclosed. The method includes (i) generating a ball model of the object from a wire mesh model of the object, (ii) generating one or more pose sequences by the generative machine learning model, wherein each generated pose of each generated pose sequence is a pose of the object, (iii) transferring, for each generated pose, the ball model into the generated pose, (iv) determining, for each generated pose, a self-overlap loss component that penalizes balls of a set of balls of the ball model overlapping in the generated pose, (v) determining a total loss that includes the determined self-overlap loss components, and (vi) training the machine learning model to reduce the total loss.

This application claims priority under 35 U.S.C. § 119 to patent application no. DE 10 2025 119 088.7, filed on May 16, 2025 in Germany, the disclosure of which is incorporated herein by reference in its entirety.

The present disclosure relates to a method for training a generative machine learning model to generate a sequence of poses of a movable object corresponding to a movement of the movable object.

### BACKGROUND

Machine learning models may be configured as motion detectors and trained to be able to determine, from a sequence of images depicting a moving object, for example, a human, how the human is moving. For example, it can be determined whether a pedestrian is walking in the direction of the roadway and should be reacted to accordingly, or whether the pedestrian remains substantially stationary, e.g., merely gesturing in a conversation.

Training motion detectors to complete such tasks requires a high number of image sequences, each representing a movement. In order to avoid the effort involved in collecting and annotating real image sequences, training images of movements can be synthesized. This may be done by a different, generative machine learning model, which in turn needs to be trained to produce such a pose sequence.

During the training of such a generative machine learning model, it generates a large number of, e.g., human poses. These poses are applied to a virtual human. Specifically, the pose is applied to the skeletal structure, and through “rigging”, the surface of the virtual human follows the pose. The resulting poses should be realistic. In particular, the machine learning model should not generate poses in which body parts overlap, e.g., arms intersect. Calculating self-overlaps based on human wire meshes is conceivable, but is unsuitable in practice for producing realistic pose sequences.

Accordingly, efficient methods for training a generative machine learning model for generating a (realistic) sequence of poses are desirable.

The publication by G. Tevet et al., “Human Motion Diffusion Model”, arXiv:2209.14916v2, October 2022, hereinafter referred to as reference [1], describes a model for generating human movements from text.

### SUMMARY

According to different embodiments, a method for training a generative machine learning model to generate a sequence of poses of a movable object corresponding to a movement of the movable object is provided, comprising:
generating a ball model of the object from a wire mesh model of the object
generating one or more pose sequences by the generative machine learning model, wherein each generated pose of each generated pose sequence is a pose of the object
transferring, for each generated pose, the ball model to the generated pose, and determining, for each generated pose, a self-overlap loss component that penalizes balls of a set of balls of the ball model overlapping in the generated pose
determining a total loss that includes the determined self-overlap loss components, and
training the machine learning model to reduce the total loss.

The method described above allows poses of movable objects (e.g., human poses) to be produced in large quantities that not only look natural but also meet high requirements for realism. This realism is achieved with a loss that can be efficiently determined from the ball model, which enables a significantly more efficient implementation than existing approaches in order to avoid self-overlaps in generated pose sequences.

In addition to generating training data, the described approach (or the trained generative machine learning model) can also be used for applications such as pose estimation (automatic pose correction/optimization) and interaction of multiple people (avoidance of overlaps with other people).

The method described above can be used to generate large quantities of realistic human movements (i.e., sequences of images showing a movable object in a sequence of poses) that contain only a few self-overlaps. Virtual avatars posed according to the generated poses can be placed in virtual environments to create synthetic images. Knowing the pose and position of the virtual avatars means that ground truth annotations for the synthetic images are available that can be utilized for training an ML (machine learning) model. Such an ML model is, for example, one that tracks objects (i.e., an “object tracker”) or a motion detection model (or “pose tracker”), i.e., an ML model that detects the movement of objects, e.g., to predict how it will move next (e.g., whether a person is walking onto a roadway, i.e., for classification of pedestrians, e.g., into critical or non-critical). They can also be used as test, verification, or validation data to verify whether a trained ML model can be operated safely.

The method described above may be used to create image sequences of people in a variety of movements and situations. In particular, movements and situations are conceivable here, which usually do not occur in training data sets (e.g., anomalies). These images can now be used to check whether a system to be tested (e.g., containing a trained ML model for tracking humans or detecting their movement) reacts robustly to these scenarios.

Various exemplary embodiments are specified in the following.

Embodiment example 1 is a method for training a generative machine learning model as described above.

Exemplary embodiment 2 is a method according to exemplary embodiment 1, wherein the total loss for each generated pose sequence also includes a motion generation loss.

The total loss is thus a combination of the usual loss of the machine learning model and the self-overlap losses. Thus, the machine learning model for generating pose sequences without self-overlaps is trained.

Exemplary embodiment 3 is a method according to exemplary embodiment 1 or 2, wherein the wire mesh model has a skeletal structure and the ball model of the object is generated by
generating a preliminary ball model from the wire mesh model
generating the ball model from the preliminary ball model by determining, for each ball of the preliminary ball model, a set of nearest points of the wire mesh model,
calculating, for each of one or more joints of the skeletal structure, a weighting of the ball by averaging weightings that the nearest points have for the joint, and
assigning the calculated weighting to the ball.

Thus, a ball model can effectively be generated for a given wire mesh model that is poseable according to a given skeletal structure.

Exemplary embodiment 4 is a method according to exemplary embodiments 1 to 3, comprising transferring, for each generated pose, the ball model to the generated pose by modifying the midpoint positions of at least a portion of the balls of the ball model, taking into account the weights associated with the balls.

In this way, the ball model can be transferred anatomically correctly into the respective pose.

Exemplary embodiment 5 is a method according to exemplary embodiment 4, wherein each generated pose specifies joint positions and the midpoint positions are modified according to the joint positions and the weights associated with the balls.

Exemplary embodiment 6 is a method according to exemplary embodiments 1 to 5, comprising determining the self-overlap loss component by, for each pair of a set of pairs of balls of the ball model, determining a value that reflects the degree of overlap of the balls of the pair of balls, and aggregating the determined values.

For example, the value is zero if there is no overlap and increases with increasing overlap. This provides a meaningful measure of self-overlap.

Exemplary embodiment 7 is a method according to any of exemplary embodiments 1 to 6, wherein the generative machine learning model is trained by backpropagating the total loss and adjusting parameters of the generative machine learning model toward a decrease in the total loss.

Thus, the machine learning model, e.g., a neural network, may be effectively trained.

Exemplary embodiment 8 is a method for generating training image sequences for a machine motion detection model, comprising generating sequences of poses of an object with the generative machine learning model trained according to any of exemplary embodiments 1 to 7 and rendering the object in the generated poses against a respective background.

This can be done by bringing the wire mesh model into the generated pose and rendering the object (i.e., an image of the object) from the wire mesh model.

For example, the machine motion detection model (also referred to as the motion detector) is trained using the training images to track objects (e.g., pedestrians) in successive images and determine behavior such as the direction of movement of the objects. Thus, for example, training videos may be generated for a motion detector and training of the detector can occur using the training videos. The motion detector may then be used to track objects in the environment of a robotic device and detect their behavior, and the robotic device may then be controlled depending on the determined behavior of the objects (e.g., people walking toward the roadway may be avoided). The term “robotic device” can be understood as relating to any technical system (with a mechanical part whose movement is controlled), such as a computer-controlled machine, a vehicle, a household appliance, an electric tool, a manufacturing machine, a personal assistant, or an access control system.

Exemplary embodiment 9 is a method for training a machine motion detection model for determining movement of objects, comprising generating training image sequences according to exemplary embodiment 8 and training the machine motion detection model using the training image sequences.

Determining the movement of an object may in particular include detecting the object in individual images. The detection of one or more objects by the machine motion detection model (or a model upstream thereof) in a training image (for its training) or in an image provided to it for use after training is to be understood according to one embodiment as the detection of the one or more objects (e.g., by classification and/or segmentation) based on the pixel values of the respective image.

Exemplary embodiment 10 is a method for controlling a robotic device, comprising training a machine motion detection model according to exemplary embodiment 9, determining one or more movements of one or more objects in an environment of the robotic device by way of the machine motion detection model, and controlling the robotic device depending on the one or more determined movements.

Exemplary embodiment 11 is a data processing system which is set up to perform a method according to one of exemplary embodiments 1 to 10.

Exemplary embodiment 12 is a computer program with instructions that, when executed by a processor, cause the processor to carry out a method according to any of exemplary embodiments 1 to 10.

Exemplary embodiment 13 is a computer-readable medium that stores instructions that, when executed by a processor, cause the processor to perform a method according to any of exemplary embodiments 1 to 10.

### BRIEF DESCRIPTION OF THE DRAWINGS

In the drawings, similar reference signs generally refer to the same parts throughout the different views. The drawings are not necessarily to scale, wherein emphasis is instead generally placed on representing the principles of the disclosure. In the following description, various aspects are described with reference to the following drawings.

FIG. 1 shows a vehicle.

FIG. 2 shows a flow chart illustrating the training of a neural network to convert a wire mesh into a ball model.

FIG. 3 shows a flow chart illustrating the generation of a ball model for a wire mesh model.

FIG. 4 illustrates the training of a machine learning (ML) model for motion generation.

FIG. 5 shows a flowchart illustrating a method for training a generative machine learning model to generate a sequence of poses of a movable object corresponding to a movement of the movable object.

### DETAILED DESCRIPTION

The following detailed description relates to the accompanying drawings, which, for clarification, show specific details and aspects of this disclosure in which the disclosure may be implemented. Other aspects may be used, and structural, logical and electrical changes may be performed without departing from the scope of protection of the disclosure. The various aspects of this disclosure are not necessarily mutually exclusive since some aspects of this disclosure may be combined with one or a plurality of other aspects of this disclosure to form new aspects.

Different examples will be described in more detail in the following.

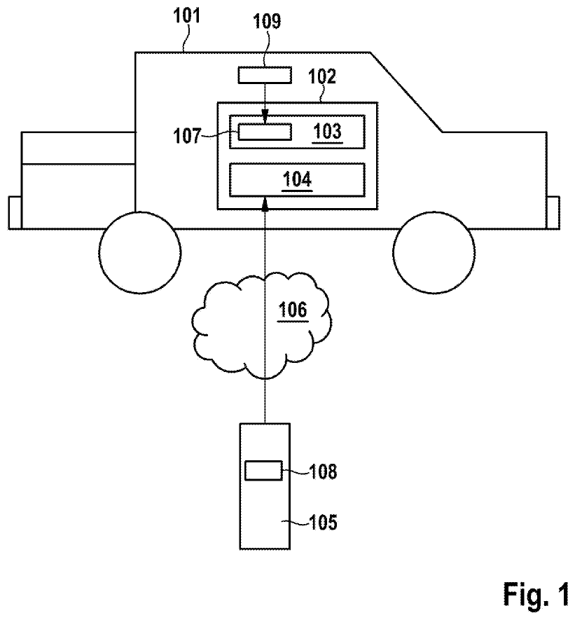

FIG. 1 shows a vehicle 101.

In the example of FIG. 1, a vehicle 101, for example a vehicle like a car or truck, is equipped with a vehicle control device 102 (e.g., an electronic control unit (ECU)).

The vehicle control device 102 has data processing components, e.g., a processor (e.g., a CPU (central processing unit)) 103 and a memory 104 for storing control software 107 according to which the vehicle control device 102 operates, and data processed by the processor 103. The processor 103 executes the control software 107 (it is therefore shown in FIG. 1 as part of the processor 103).

For example, the stored control software (computer program) comprises instructions that, when executed by the processor, cause the processor 103 to execute driver assistance functions or even to control the vehicle autonomously.

The control software 107 is, for instance, transmitted to the vehicle 101 from a computer system 105, for example via a network 106 (or also using a storage medium such as a memory card). This can also be done during operation (or at least when the vehicle 101 is with the user), because over time the control software 107 is updated to new versions, for example.

The control software 107 can, for example, be trained by way of machine learning (ML), i.e., the control software 107 implements one or more ML models 108 (or machine learning model), which is trained on the basis of training data, by computer system 105 in this example. The computer system 105 thus implements an ML training algorithm for training the one or more ML models 108, which serve for tracking other traffic participants, e.g. pedestrians. It may also be of interest to determine the type of movement of humans (or even animals). For example, for a person who is substantially stationary while sitting on the roadside, there is only a low risk that he or she will quickly move onto the roadway. However, if a person is walking toward the roadway, this risk is high; the pedestrian is classified as critical, for example, and the vehicle should be driven slowly, for example.

Training of such an ML model 108, hereinafter referred to as a machine motion detection model, such as a neural network for classifying a type of motion of an object, requires a large amount of training data. For example, as in the example above, if an ML model 108 is to be trained that performs 3D pose tracking, i.e., an ML model that is to track people and their poses in images, thousands of videos are needed for the training that represent people in various movements. In addition, these videos must be marked (“annotated”) showing where the people can be seen in which poses. The taking and annotating of images is time-consuming and costly, especially since this is three-dimensional data with human body poses. Because the data includes people, data protection law aspects are also added.

One way to reduce these difficulties is by using synthetically generated (image) data. The advantages include that a large amount of this data can be produced at low cost and additionally the annotations of the data can be co-created automatically and in a highly accurate manner. Here, data protection aspects also do not apply.

However, in the synthetically generated data, people must be represented in realistic poses so that ML models trained on the synthetic data work smoothly for real data (real images), i.e., the ML model is trained to generalize to real cases.

Human motion generation uses methods of generative artificial intelligence, i.e., generative machine learning models, to generate arbitrary human motion sequences. The goal of human motion generation is to generate natural and realistic human motion. A movement is composed of individual poses, which, when strung together, represent the movement. A pose is usually defined for a skeletal structure of the virtual human. The pose describes the position or rotation of the joints of this skeletal structure. If a pose has been generated (e.g., represented by a set of joint positions for a given skeletal structure), an image may be rendered therefrom showing the respective human (or also another movable object) in the respective pose (e.g., for a specific background). In this way, a sequence of images may be generated that shows a human (or other movable object) in a sequence of poses, and thus in a particular movement.

For rendering, typically in addition to the skeletal structure of a virtual human, a “skin” is provided, which represents the outer appearance of the virtual human. This “skin” is usually depicted with polygonal wire meshes consisting of triangles.

The “skin” is coupled to the underlying skeletal structure. This process is called “rigging” in the area of 3D animation. The goal of rigging is for the “skin” to move along according to the movements of the skeleton. The volume is not explicitly considered, which means that overlaps and changes in the volume can only be tested or corrected in a time-consuming manner.

The text-to-motion sub-area of human movement generation is additionally concerned with controlling the generation process with text descriptions. Here, a text description of a movement is given, and the corresponding method is intended to generate a human movement that matches the text description. There are already some approaches that solve this problem well (e.g., the “Human Motion Diffusion Model”, see reference [1]). Artificial neural networks are commonly used for generation.

However, such approaches are limited to motion, i.e., the generation of various body joint positions, so-called poses; the body shape of the human being, i.e., whether a human being is heavy or thin, and the skin or body tissue are typically neglected.

However, the body shape significantly determines the possible movement in addition to the joint positions. As a result, poses generated with such approaches often contain self-overlaps. In these self-overlaps, for example, the generated person's arm is stuck in their upper body, their arms overlap each other (e.g., their forearms penetrate each other), or their fingers penetrate their upper arms or chest, which is not realistic. In order to be able to define and measure self-overlap at all, such approaches require the above-mentioned “skin”. Self-overlap always occurs when two triangles of the polygonal wire mesh representing the skin collide, i.e., when a line of intersection can be found for the surfaces of the triangles.

According to various embodiments, there is provided an approach for training a machine learning model for generating movements, i.e., a sequence of images representing a human in motion (i.e., in a sequence of poses: each image shows the human in a respective pose), so as to avoid self-overlaps. The machine learning model is thus trained such that in each of the poses it generates (at least relevant, e.g., apparently visible or apparently unrealistic) self-overlaps are avoided (e.g., only a few or irrelevant self-overlaps occur). It should be noted that humans are hereinafter referred to, but the approach described herein may also be used to create sequences of poses for animals or robots or other movable objects.

There are approaches that determine self-overlaps in human wire meshes. However, these have a high computational cost and cannot readily be integrated into the training of generative ML models for human motion generation.

According to various embodiments, a ball model of human geometry is instead used to allow training that leads to the generation of self-overlap-free movements, i.e., sequences of poses without self-overlaps. The ball model allows for a fast and efficient calculation of self-overlaps and can be integrated into existing human motion generation methods (especially those employing generative ML models).

Avoidance of self-overlaps in poses generated by a generative ML model is achieved according to various embodiments by using a loss function based on the ball model for training the generative ML model and explicitly penalizing self-overlaps.

Thus, according to various embodiments, there is provided a loss function for training a generative ML model (which serves as the basis for a motion generation method) that allows the ML model to be trained to produce sequences of poses that avoid self-overlaps. The loss function includes a self-overlap loss component determined by a ball model of the respective movable object, hereinafter a human by way of example.

In the following, it is first described how such a ball model can be generated for a given wire mesh model of a (virtual) human (and analogously for another movable object).

For a ball model, the human 3D geometry is approximated by a number of posable balls (i.e., a posable ball model following a skeletal structure according to various embodiments), allowing for efficient collision calculations to efficiently check for self-overlapping.

The goal here is to first position a set of balls in three-dimensional space such that the surface of the balls represents the surface of a virtual person. For this purpose, it is assumed that SDF values of points in the space (i.e., SDF values of points in the space with respect to the respective wire mesh) are available for different wire meshes of virtual people. The set of these points is hereinafter referred to as a predetermined set of points in space. For example, they may be randomly selected and then the SDF values of these points can be calculated relative to the wire mesh (e.g., by calculating the distance to each triangle of the wire mesh and establishing the minimum across those distances).

The signed distance function (SDF) is one way to mathematically represent 3D geometry. It can be constructed using a wire mesh of the 3D geometry (in the present example, the shape of a person). For any point in space (for which an SDF value is to be determined), the smallest distance of the point to the surface of the wire mesh is calculated. By way of the sign of the distance, it is possible to represent whether the point is inside (negative sign) or outside (positive sign) of the wire mesh. Points on the surface of the wire mesh have an SDF value of zero. Thus, the surface of an object of 3D geometry can be represented by a set of points with associated SDF values.

A ball model may be generated using SDF values for a given wire mesh as follows: First, it should be noted that an SDF value can be determined for a set of balls for any point in space. For this purpose, the smallest distances to the surfaces of all balls are determined for the point in space. The smallest of these distances is used as the SDF value for the point (relating to the set of balls). To generate a ball model for a given wire mesh, the midpoints and the radii of the balls are adjusted to minimize the error between the SDF values of the points relative to the set of balls and the SDF values of the points relative to the wire mesh. In this way, the surface of the wire mesh is approximated by the surfaces of the balls.

To achieve generalizability of the method for different wire meshes, a neural network can be used. The task of this network is to predict the parameters of the balls. The input variable of the neural network is sampled from a hidden state space (i.e., a latent space) according to a probability distribution, the parameters of which are learned during training (e.g., a Gaussian normal distribution). As a result, similar ball models have similar values in the hidden state space. This property can then be exploited to transition any wire mesh into a ball model.

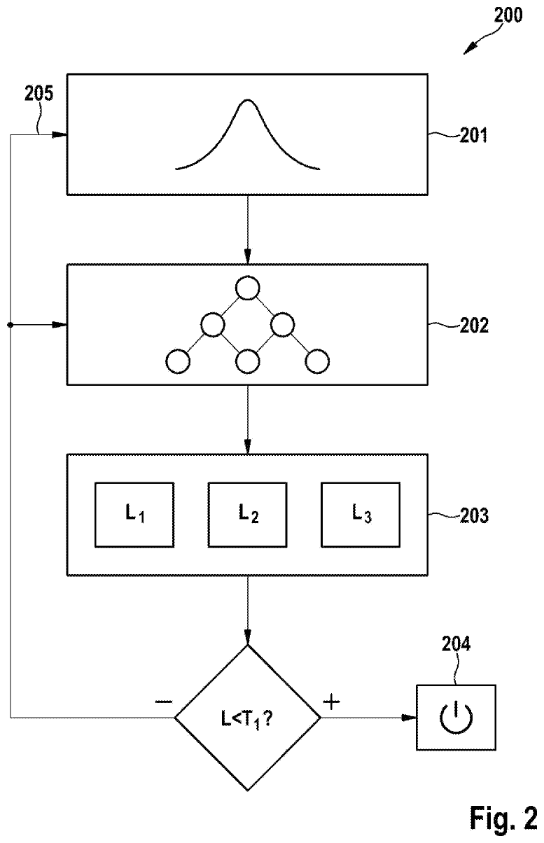

FIG. 2 shows a flow chart 200 illustrating the training of a neural network to convert a wire mesh into a ball model.

In 201, a state vector is first sampled from a hidden state space. This occurs according to a probability distribution with certain parameters, e.g., a Gaussian normal distribution with the mean and the variance as parameters (which are initially set to start values but are adjusted during the training).

The sampled state vector is fed in 202 to the neural network (to be trained) (e.g., which was initially initialized with random weights) as an input, which network determines the parameters of the ball model (midpoints of the balls and their radii) on this basis.

For this purpose, in 203, three loss components (i.e., components of a loss function) are determined
1) errors between the SDF values of the points of the predetermined set of points in space relative to the set of balls and the SDF values of the points of the predetermined set of points in space relative to the wire mesh.
2) Deviations between the probability distribution from which sampling is performed from the latent space and a predetermined probability distribution (e.g., difference between the mean of the Gaussian distribution of 0 and difference between the variance of the Gaussian distribution from 1)
3) errors that evaluate whether all balls of the determined ball model contain a point within the wire mesh (or at least exactly on the wire mesh), i.e., at least partially overlap the wire mesh model. This is, for example, a sum of individual errors across all balls of the ball model, wherein the individual error of a ball is zero, for example, if the ball contains a point within (or on) the wire mesh, and, for example, the farther the point of the ball closest to the wire mesh is from the wire mesh, the larger the error becomes.

If the value of the loss function (with these three components, e.g., calculated over a batch of training wire mesh models) is small enough (i.e., below a predetermined threshold), the training is ended in 204.

If the error is not small enough, in 205, the parameters of the neural network and the parameters of the probability distribution are adjusted towards decreasing the loss function (via backpropagation) and the training is iteratively continued (typically for a new batch).

Thus, based on the loss function, both the neural network and the probability distribution parameters that are sampled from the latent space are adjusted. For example, the expected value and variance of a Gaussian normal distribution are adjusted such that a state vector that would provide a low value for the loss function becomes more likely than the sampled one (e.g., viewed on average across a batch).

With respect to the third component of the loss function as described above, it should be noted that for any point with an associated SDF value, there are any number of placements of a ball to achieve the same SDF value for the point. In particular, balls may be placed inside or outside the wire mesh to be approximated by the ball model. For a realistic approximation of the wire mesh, it is desired that all balls lie within the wire mesh. Therefore, the third component of the loss function during the training requires that each ball contains at least one point, which was originally within the wire mesh.

After training the neural network, it may be used to transform any wire mesh of a virtual person into a ball model.

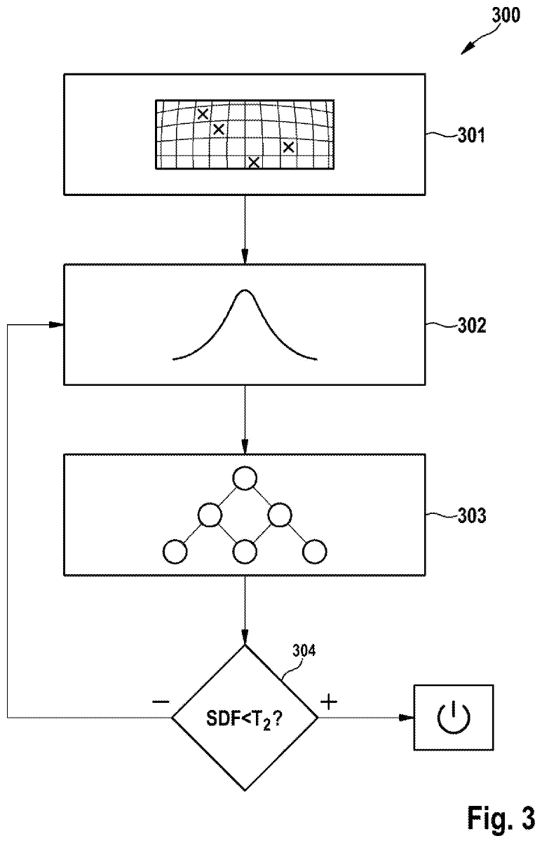

FIG. 3 shows a flowchart 300 illustrating the generation of a ball model for a wire mesh model.

In 301, points are determined on the surface of the wire mesh (their SDF values relative to the wire mesh are zero).

At 302, a state vector is sampled from the latent space according to the probability distribution learned.

In 303, the trained neural network is used to obtain a ball model, i.e., a set of balls with their position in space and their radii, from the Gaussian state vector. These balls may not reflect the desired wire mesh well enough yet.

Thus, in 304, SDF values of the points determined on the surface of the wire mesh are calculated relative to the ball model and summed to an error. By way of an optimization method for minimizing this error, a state vector is now sought, which, when used as an input to the neural network, leads to such error being as small as possible. Thus, the state vector is iteratively changed, supplied to the neural network, and the error for the resulting ball model is calculated until the error is sufficiently small.

Alternatively, a second upstream neural network (encoder) may also provide the state vector that directly predicts certain points on the wire mesh. This encoder must then be additionally trained either together (jointly) with the downstream neural network (which can determine the ball model from the state vector and be seen as a decoder) or subsequently with training data.

If a desired wire mesh has now been transferred to a ball model, it can be brought into a specific pose. To do this, the balls must be posed according to the underlying skeletal structure. For this purpose, the skeleton of the underlying wire mesh (i.e., the virtual skeleton of the wire mesh) can be used directly.

To do this, the balls of the ball model are associated with the joints of the skeleton so that the balls can move according to the joints. The underlying wire mesh is also used for this purpose. Each point of the wire mesh has corresponding skeleton weights, which are used to associate the point with the joints of the skeleton. For each ball, the distance from the surface of the ball to the points of the wire mesh is now determined. Thus, a set of wire mesh points may be determined that are nearest to the ball (e.g., eight). By interpolating the skeleton weights for these nearest points, a skeleton weight can be determined for each ball. This results in a posable ball model, which can be brought into a particular pose by transferring an initial pose (e.g., standard pose), in which the posable ball model is initially located, into the pose by changing the positions of the balls while taking into account the skeletal structure (i.e., the weights of the balls to the skeleton). For this purpose, the midpoints of the balls are moved (taking into account their weights), and the points of a wire mesh would be moved (taking into account their weights), such as in a method like linear blend skinning. The positions of joints are changed according to the pose into which the ball model is to be brought (based on the joint positions of the initial pose), and the resulting new positions of the ball centers are determined.

If a desired wire mesh has been converted to a ball model, it may be used to train an ML model for motion generation as follows.

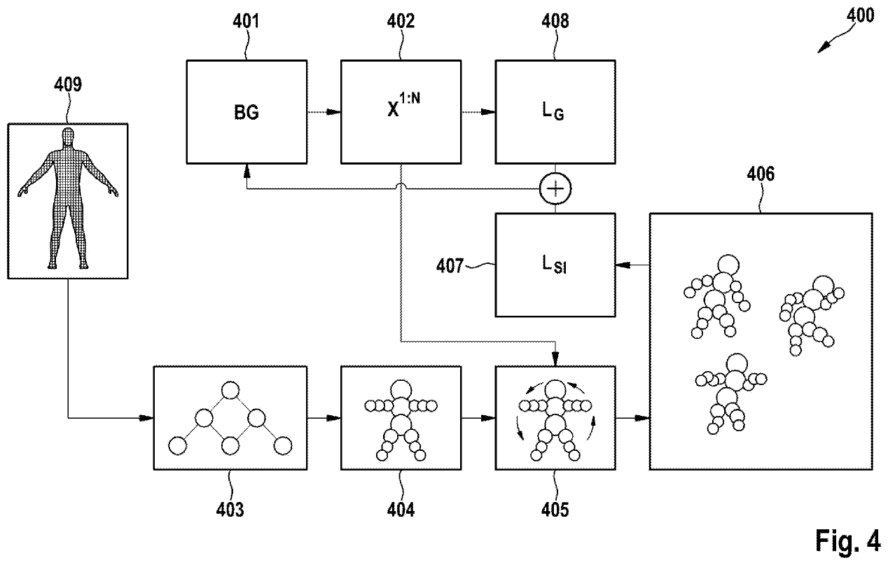

FIG. 4 illustrates training of an ML model 401 for motion generation, i.e., a motion generator (BG).

In training, the ML model 401 generates a sequence of successive poses 402 corresponding to a movement. It is assumed that a wire mesh model 409 is present for a human (or the respective movable object). Depending on the configuration of the ML model 401, the ML model 401 can use the wire mesh model 409, but it can also be trained for a particular object (e.g., for humans) so that it does not require a wire mesh model. For example, the model from reference [1] that generates pose sequences from text inputs is used.

For the wire mesh model 409, for example, a neural network 403 trained as described with reference to FIG. 2 generates a ball model 404 for the wire mesh model (in a standard pose) (e.g., as described with reference to FIG. 3). The generated poses are applied to this in 405, i.e., the ball model 404 is transferred into the pose for each of the generated poses 402, which may also be considered rigging. The result is a set of posed ball models 406.

For each generated pose, i.e., for each posed ball model 406, it is checked which balls of the posed ball model 406 intersect in this pose. According to one embodiment, overlap distances b are calculated for ball pairs (i.e., pairs of balls of the ball model): For a pair of balls, this is the distance between the center points c of the balls, minus the sum of the radii r of the balls. If this value is less than zero, the balls do not overlap. If this value is greater than zero, the balls are considered to overlap. This value can be used directly for the self-overlap loss component 407, referred to as LSI.

As a formula, the overlap distance of a pair of balls with the balls of index i and j may be expressed as

b_{i,j}=max(rᵢ+rⱼ−∥cᵢ−cⱼ∥,0)

For a pose, the sum of the squared overlap distances bi,j of all considered ball pairs is formed, and then the average over all generated poses 402 is calculated to compute the self-overlap loss component 407.

It should be noted that it typically does not make sense to compare all balls of a pose with each other, i.e., to consider all possible ball pairs. For example, adjacent balls will always overlap, regardless of the pose. In addition, balls representing the same body part will never overlap because they move together for each pose (for example, two balls that are both located on the forearm). Such ball pairs (i.e., those of balls that always or never intersect) are therefore excluded from the calculation of the self-overlap loss component 407. The set of remaining ball pairs is referred to as W. This allows the self-overlap loss component 407 to be expressed as

$${L}_{SI} = \frac{1}{N} {\sum }_{n = 1}^{N} {\sum }_{( i , j ) ∈ w} {( {b}_{i , j} )}^{2}$$

wherein N is the number of generated poses 402. The b(i,j) depend on the individual poses (but the pose index n is omitted for simplicity).

The self-overlap loss component 407 is added to the “usual” motion generation loss 408, referred to as LG, of the ML model 401, which may differ depending on the specific method. The motion generation loss 408 is, for example,
a mean squared error (MSE): This loss measures the average squared difference between the predicted movement and the actual movement.
an L2 loss: Similar to MSE, the L2 loss penalizes larger errors more and helps produce smoother and more accurate motion sequences.
a perceptual loss: This loss measures the difference in perceived quality between the generated movement and the real movement, e.g., using features extracted from pretrained models.

Then (e.g., by summing LSI+LG (calculated for each generated pose sequence) over a batch of pose sequences), an overall loss is generated, to reduce which the ML model 401 is adjusted (typically by backpropagating the overall loss (backward via the rigging 405 to the skeletal structure and further to the ML model 401) and adjusting the parameters (typically weights) of the ML model 401 in the direction of decreasing overall loss). As a result, motion generators, such as the ML model 401, can be trained (i.e., their parameters optimized) independently of the generative method they use, so that they avoid self-overlaps.

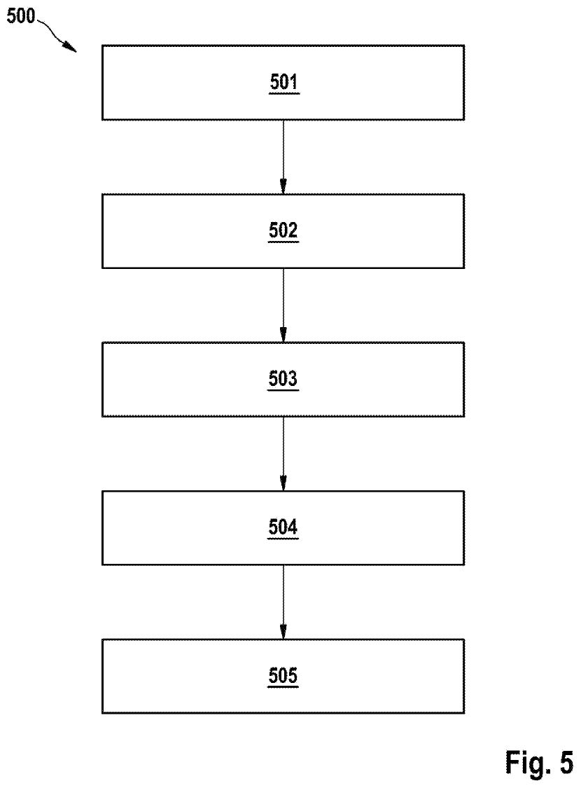

In summary, according to various embodiments, a method as shown in FIG. 5 is provided.

FIG. 5 shows a flowchart 500 illustrating a method for training a generative machine learning model to generate a sequence of poses of a movable object corresponding to a movement of the movable object.

At 501, a ball model of the object is generated from a wire mesh model of the object.

At 502, one or more pose sequences are generated by the generative machine learning model, wherein each generated pose of each generated pose sequence is a pose of the object.

At 503, for each generated pose, the ball model is transferred to the generated pose and, for each generated pose, a self-overlap loss component is determined that penalizes when balls of a set of balls of the ball model overlap in the generated pose.

At 504, a total loss is determined that includes the determined self-overlap loss components.

At 505, the machine learning model is trained to reduce the total loss.

The method of FIG. 5 may be performed by one or a plurality of computers comprising one or a plurality of data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or a plurality of the method steps described in detail here may be carried out (e.g., implemented) by a data processing unit by way of one or a plurality of specific functions performed by the data processing unit.

According to various embodiments, the method is thus, in particular, computer-implemented.

What is claimed is:

1. A method for training a generative machine learning model to generate a sequence of poses of a movable object corresponding to a movement of the movable object, comprising:
generating a ball model of the object from a wire mesh model of the object;
generating one or more pose sequences by the generative machine learning model, wherein each generated pose of each generated pose sequence is a pose of the object;
transferring, for each generated pose, the ball model to the generated pose;
determining, for each generated pose, a self-overlap loss component that penalizes balls of a set of balls of the ball model overlapping in the generated pose;
determining a total loss that includes the determined self-overlap loss components; and
training the machine learning model to reduce the total loss.

2. The method according to claim 1, wherein the total loss for each generated pose sequence also includes a motion generation loss.

3. The method according to claim 1, wherein the wire mesh model has a skeletal structure and the ball model of the object is generated by:
generating a preliminary ball model from the wire mesh model;
generating the ball model from the preliminary ball model by determining, for each ball of the preliminary ball model, a number of nearest points of the wire mesh model;
calculating, for each of one or more joints of the skeletal structure, a weight for the ball by averaging the weights of the points nearest to the joint; and
assigning the calculated weight to the ball.

4. The method according to claim 1, further comprising transferring, for each generated pose, the ball model to the generated pose by modifying the midpoint positions of at least a portion of the balls of the ball model, taking into account the weights associated with the balls.

5. The method according to claim 4, wherein each generated pose specifies joint positions and the midpoint positions are modified according to the joint positions and the weights associated with the balls.

6. The method according to claim 1, further comprising:
determining the self-overlap loss component by, for each pair of a set of pairs of balls of the ball model;
determining a value that reflects the degree of overlap of the balls of the pair of balls; and
aggregating the determined values.

7. The method according to claim 1, wherein the generative machine learning model is trained by backpropagating the total loss and adjusting parameters of the generative machine learning model toward a decrease in the total loss.

8. A method for generating training image sequences for a machine motion detection model, comprising:
generating sequences of poses of an object with the generative machine learning model trained according to the method of claim 1; and
rendering the object in the generated poses against a respective background.

9. A method for training a machine motion detection model for determining movement of objects, comprising:
generating training image sequences according to the method of claim 8; and
training the machine motion detection model using the training image sequences.

10. A method for controlling a robotic device, comprising:
training a machine motion detection model according to the method of claim 9;
determining one or more movements of one or more objects in an environment of the robotic device by way of the machine motion detection model; and
controlling the robotic device depending on the one or more determined movements.

11. A data processing system configured to carry out the method according to claim 1.

12. A computer program with instructions that, when executed by a processor, cause the processor to carry out the method according to claim 1.

13. A computer-readable medium that stores instructions that, when executed by a processor, cause the processor to carry out the method according to claim 1.
